(19) United States
(12) Patent Application Publication
(10) Pub. No.: US 2002/0159741 A1
(43) Pub. Date: Oct. 31, 2002

(54) Optical transmission tube and applications thereof

(76) Inventors: Stephen M. Graves, Rentwood, TN (US); Minoru Ishiharada, Urawa-shi (JP)

Correspondence Address: Chief Intellectual Property Counsel, Bridgestone/Firestone Americas Holding, Inc., 1200 Firestone Parkway, Akron, OH, 44317, US

(21) Appl. No.: 10/082,833

(22) Filed: Feb. 25, 2002

Related U.S. Application Data
(60) Provisional application No. 60/271,462, filed on Feb. 26, 2001.

(51) Int. Cl. G02B 6/00; F21V 8/00

(52) U.S. Cl. 385/133; 385/147; 385/901; 362/559

(57) ABSTRACT

An optical transmission tube for illumination is uniquely incorporated into any one of a variety of automotive, commercial, retail, structural, architectural, safety, or other products including running boards, vehicle interior compartments such as a glove box, approximate the license plate attachment area on a vehicle, a trunk, a vehicle hood, on a vehicle door, a vehicle bumper, a vehicle luggage rack, a picture frame, a flashlight, a building, a guard rail, a construction barrier, a bicycle, a sign, an appliance interior compartment such as a refrigerator, a part bin, a retail display shelf, a clipboard, a step, a tractor trailer, a desk, a walkway, a room or storage chamber, a runway, an instrument panel, a railroad crossing gate, an emergency sign, an elevator doorway, a swimming pool, a dog collar, a fish tank, a baby crib a hand rail, an inline skate an island in a parking lot or on a street, affixed to a curb, or on safety clothing.

Under 35 USC 119(e), this application claims the benefit of earlier filed provisional application NO. 60/271,462, filed on Feb. 26, 2001.

### BACKGROUND OF THE INVENTION

1. Technical Field

The invention relates to devices incorporating optical transmission tube lighting systems to illuminate the area in the vicinity of the lighting system.

2. Background Information

It is desirable or imperative for safety, aesthetic, security, convenience and other reasons to illuminate areas, products, devices, and the like. These include vehicles in general and the many compartments, edges or chambers thereof, and areas surrounding a structure or vehicle for safety and security purposes. These also include roads or other spaces the vehicles or other moving devices such as airplanes and boats traverse, and construction sites and the structures used in association therewith. Other examples include structures and buildings including edges, cavities, outlying regions or the like thereof. These further include retail spaces or storage areas or shelves. Previously in the art, such illumination has either (1) not been accomplished at all due to prohibitive cost, engineering impossibility, bulkiness, undesirable design such as excessive heat buildup, or the like, or (2) has been accomplished using a variety of solutions that are inefficient, expensive in initial cost or to operate, uneven or insufficient in light distribution, energy inefficient, dangerously hot in operation, bulky or large in dimension for the application or space available, or the like.

One example is vehicle interior illumination that has been accomplished using position specific light bulbs. These bulbs included no more than marginal light directional control, were generally of insufficient focus or directionality, did not evenly illuminate an entire area, and illuminated in undesirable warm or hot temperatures.

It is thus desirable to invent, design, develop, conceive and/or reduce to practice a novel, useful and nonobvious devices incorporating optical transmission tubes.

### SUMMARY OF THE INVENTION

There is a need in the art for a means of delivering light to specific locations to illuminate a surface or space with control of directionality.

The present invention is a directional optical transmission tube that includes a tubular transparent body capable of allowing light to be transmitted both substantially along its entirety and in a limited angle of circumference from a light source positioned approximate an end of the tube. The tube is optimally affixed to provide illumination from the tube toward a structure, a feature thereof such as an edge or face, a compartment therein, a space therearound or thereunder, or to accent or backlight the structure or features thereon.

The optical transmission tube is uniquely incorporated into any one of a variety of automotive, commercial, retail, structural, architectural, safety, or other products.

Non-limiting examples of these products for vehicles are vehicle running boards, vehicle interior compartments such as a glove box, a location proximate to the license plate attachment area on a vehicle, a trunk, a vehicle hood, on a vehicle door, a vehicle bumper, a vehicle luggage rack, and other vehicle locations.

Non-limiting examples of these products in other locations include a picture frame, a flashlight, a building, a guard rail, a construction barrier, a bicycle, a sign, an appliance interior compartment such as a refrigerator, a part bin, a retail display shelf, a clipboard, a step, a tractor trailer, a desk, a walkway, a room or storage chamber, a runway, an instrument panel, a railroad crossing gate, an emergency sign, an elevator doorway, a swimming pool, a dog collar, a fish tank, a baby crib a hand rail, an inline skate an island in a parking lot or on a street, affixed to a curb, or on safety clothing.

A feature of the invention is the use of existing directional optical transmission tubes as a light source in a manner to control directionality of the lumens of light emanating from the light source to a specific space or surface area of an object.

An advantage of the invention is the ability to provide directional light in a manner that minimizes energy use or energy loss in the form of heat from the light source, because a directional optical transmission tube is used.

Further features and advantages are described below. “Directional optical transmission tube” means any of several devices where the source of light is remote from the location(s) of light emanation from the tube. Preferably, the optical transmission tubes are those types of devices disclosed in U.S. Pat. No. 5,982,969 which is hereby incorporated by reference. Also incorporated by reference are other commonly owned U.S. patents on light transmission tubes including U.S. Pat. Nos. 5,557,702; 5,933,560; 5,681,611; 5,546,493; 5,638,480; 5,684,913; 5,692,088; 5,737,471; 5,333,227; 6,030,108; 6,104,857; 6,236,797; 6,278,827; 4,830,461; 5,922,250; 6,169,836; and 4,937 029.

Embodiments of the invention are described with respect to the following drawings.

### BRIEF DESCRIPTION OF THE DRAWINGS

FIG. 1 is a view of a vehicle running board with an optical transmission tube about an outer edge;

FIG. 1A is a view of a vehicle running board with an optical transmission tube about an inner edge;

FIG. 2 is a view of a vehicle interior compartment such as a glove box with an optical transmission tube on the access door or panel;

FIG. 2A is a view of a vehicle interior compartment such as a glove box with an optical transmission tube inside of the compartment or along the periphery thereof;

FIG. 3 is a view of a license plate attachment area on a vehicle with an optical transmission tube for illuminating the license plate from the bottom;

FIG. 3A is a view of a license plate attachment area on a vehicle with an optical transmission tube for illuminating the license plate from the top either affixed to the plate itself or alternatively to the frame or vehicle the plate is attachable to or within;

FIG. 4 is a view of a vehicle interior compartment such as a trunk with an optical transmission tube along the periphery or within the compartment;

FIG. 4A is a view of a vehicle interior compartment such as a trunk with an optical transmission tube along the periphery or edge of the cover, trunk lid or the like;

FIG. 5 is a view of a truck bed with an optical transmission tube therein;

FIG. 6 is a view of a vehicle hood with an optical transmission tube thereon;

FIG. 7 is a view of a vehicle exterior side with an optical transmission tube thereon such as at the edge where the side panels such as doors and quarter-panels meet the undercarriage;

FIG. 7A is a view of the interior of a vehicle door with an optical transmission tube within the door panel;

FIG. 7B is a view of the interior of a vehicle door with an optical transmission tube at the base of the door panel or along the lower face of the door;

FIG. 8 is a view of a vehicle bumper with an optical transmission tube therein;

FIG. 8A is a view of a rear vehicle window with an optical transmission tube therein;

FIG. 9 is a view of a vehicle luggage rack with an optical transmission tube therein;

FIG. 10 is a view of a picture frame with an optical transmission tube thereon;

FIG. 11 is a view of a flashlight including an optical transmission tube;

FIG. 12 is a view of a building with optical transmission tubes thereon;

FIG. 12A is a view of a building with optical transmission tubes thereon;

FIG. 13 is a view of a guard rail with an optical transmission tube therein;

FIG. 14 is a view of a construction barrier with an optical transmission tube therein;

FIG. 15 is a view of a bicycle with an optical transmission tube thereon for safety either or both illuminating the bicycle frame or as a flag;

FIG. 16 is a view of a vehicle exterior back side with an optical transmission tube thereon functioning as a light;

FIG. 17 is a view of a vehicle exterior back side with an optical transmission tube thereon functioning as a third brake light (center high mount stop light referred to as “CHMSL” in the automotive industry);

FIG. 18 is a view of a portable vehicle or home reading light including an optical transmission tube therein;

FIG. 19 is a view of a sign with an optical transmission tube thereon outlining the lettering;

FIG. 20 is a view of an appliance interior compartment such as a refrigerator with an optical transmission tube therein either or both on a shelf or edge thereof, in the compartment or on the door;

FIG. 21 is a view of a part bin with an optical transmission tube thereon;

FIG. 22 is a view of a retail display shelf with an optical transmission tube thereon and positioned for underlighting;

FIG. 23 is a view of a retail display shelf with an optical transmission tube thereon and positioned for shelf edge illumination;

FIG. 24 is a view of a clipboard with an optical transmission tube along the clip;

FIG. 24A is a view of a clipboard with an optical transmission tube along the side to aid in illumination during writing;

FIG. 25 is a view of a step with an optical transmission tube in the valley portion thereof and directed to illuminate the tread or walking area;

FIG. 25A is a view of a step with an optical transmission tube on an outer edge thereof and directed to illuminate the edge and the tread or walking area therebelow;

FIG. 26 is a view of a tractor trailer with an optical transmission tube thereon;

FIG. 27 is a view of a desk with an optical transmission tube thereon to illuminate a work area;

FIG. 28 is a view of a walkway with vertical individual walkway path edge markers with an optical transmission tube therein;

FIG. 28A is a view of a walkway with an elongated walkway path edge marker with one or more optical transmission tubes therein;

FIG. 29 is a view of a room or storage chamber with an optical transmission tube therein;

FIG. 30 is a view of a runway with vertical individual runway markers including an optical transmission tube thereon;

FIG. 30A is a view of a runway with an elongated runway marker including an optical transmission tube thereon;

FIG. 31 is a view of an instrument panel with an optical transmission tube thereon;

FIG. 32 is a view of a railroad crossing gate with an optical transmission tube thereon;

FIG. 33 is a view of an emergency sign with an optical transmission tube therein;

FIG. 34 is a view of an elevator doorway with an optical transmission tube thereon;

FIG. 34A is a view of elevator doors with an optical transmission tubes thereon;

FIG. 35 is a view of the interior of an elevator with an optical transmission tube therein;

FIG. 36 is a view of a swimming pool with an optical transmission tube along the edge thereof;

FIG. 37 is a view of a swimming pool with an optical transmission tube therein;

FIG. 37A is a view of a swimming pool with a slope change edge and steps therein with an optical transmission tubes thereon;

FIG. 38 is a view of a dog collar with an optical transmission tube thereon;

FIG. 39 is a view of a hazard such as a snow plow extending from a vehicle, with an optical transmission tube on the hazard;

FIG. 40 is a view of decorative letters including an optical transmission tube therein;

FIG. 41 is a view of a fish tank with optical transmission tubes therein;

FIG. 42 is a view of baby crib with optical transmission tubes thereon;

FIG. 43 is a view of a hand rail with an optical transmission tube affixed thereto or incorporated therein;

FIG. 44 is a view of an inline skate with an optical transmission tube affixed thereto;

FIG. 45 is a view of an island in a parking lot or on a street where an optical transmission tube is affixed or incorporated into the curb, and optical transmission tubes are incorporated into the road surface to indicate lanes;

FIG. 45A is a view of an optical transmission tube affixed to a curb;

FIG. 46 is a view of safety clothing including optical transmission tubes therein; and

FIG. 47 is a view of a parts bin with optical transmission tubes illuminating each bin.

Similar numerals refer to similar parts throughout the drawings.

### EMBODIMENTS OF THE INVENTION

Referring now to the drawings and the following exemplary descriptions of the present invention, there is shown and described illustrative embodiments of the invention. It is appreciated that these drawings and description are not limiting, and that the present invention can be used in other applications and can be realized in different embodiments.

Generally, the invention is an optical transmission tube 1 incorporated into any one of a variety of automotive, commercial, retail, structural, architectural, safety, or other products. The optical transmission tube 1 includes a tubular transparent body capable of allowing light to be transmitted substantially along its entirety from a light source 2 positioned approximate to the end of the tube. The tube 1 can be affixed to provide illumination to a structure, a feature thereof such as an edge or face, a compartment therein, an area therearound or thereunder, or to accent or backlight the structure or features thereon.

In one embodiment, the tube 1 includes a tubular transparent cladding having inner and outer surfaces and a transparent core coaxially disposed within the cladding. The core has a higher index of refraction than the cladding.

A reflecting layer 3 in a strip form is disposed between the cladding and the core. The configuration of the strip form is such that the reflecting layer extends longitudinally of the cladding and in an arcuate manner on one side of the tube (although several reflecting layers can be used allowing for reflecting on multiple sides of the tube). The reflecting layer can have a certain thickness extending from the core surface toward the interior. With this construction, light passing through the core is reflected and scattered by the reflecting layer and emerges from the tube through an area of the outer surface of the cladding that is approximately diametrically opposed to the reflecting layer. This is disclosed in more detail in U.S. Pat. No. 5,982,969 which is hereby incorporated by reference.

In most applications the reflecting layer need only be flat or of a simple curvature as described in the '830 patent. However and preferably for this invention, the reflecting layer can be of a more complex curvature, such as concave or convex, as is necessary or desirable to better control the emanation of light from the tube toward the space or surface being illuminated. In the case of a concave reflecting layer, the angle or area of illumination can be increased while still maintaining substantial control of the light direction and intensity or brightness focused in that direction. In the case of a convex reflecting layer, the angle or area of illumination can be decreased and more intensely focused on a desired illumination area.

The tube 1 is incorporated into the following device or products: vehicle running boards, vehicle puddle lights (lights to activate when a door is opened to illuminate the ground where the first passenger step is likely to occur), vehicle interior compartments or panels, license plate brackets or areas, trunk or cargo compartments, vehicle side trim, bumpers, glove compartments, luggage racks, picture frames, flash lights, building architectures, guard rails or other road curve, straight or edge delineation markers, bicycles, vehicle braking lights, vehicle or home reading lights, signs for outlining or back illumination, street signs, refrigerators or appliance interior compartments, parts bins, retail display shelves as underlighting or shelf edge illumination, clipboards, floors or steps, trailer edge illumination, road work barriers or cones, desks, security light, walkway path edge marker, walls of a storage chamber or room, edges of runways or markers along runways or other landing zones, edges of walkways or along step front edges, instrument panels, railroad crossing gates, glass block, emergency lights such as exit signs, elevator doors or edges, pools, toys, dog collars, hazards extending into a walkway or other path, and decorative letters.

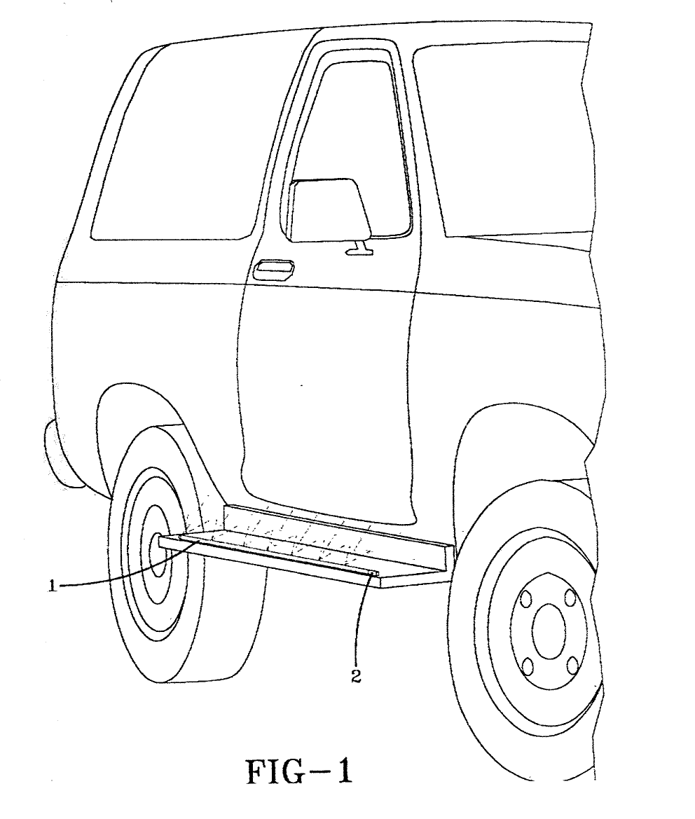

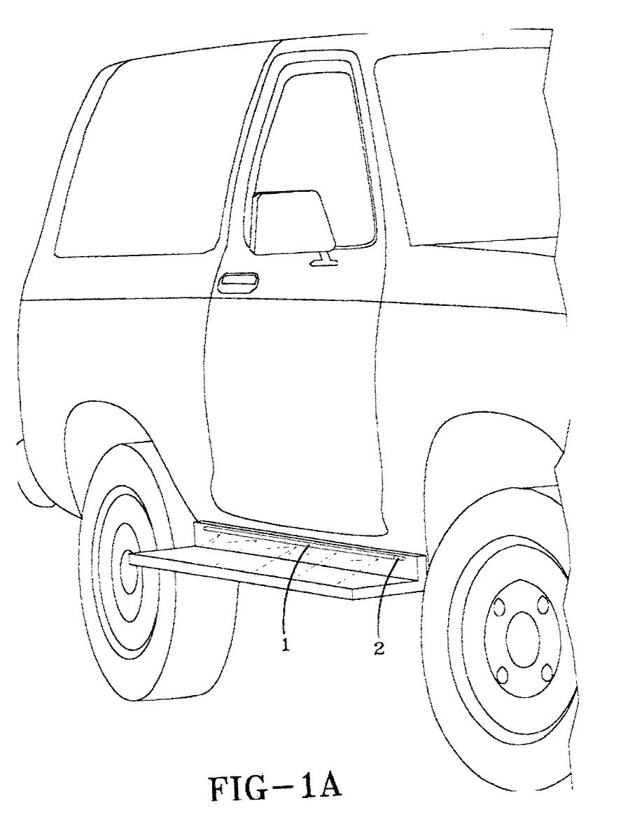

The embodiment of the optical transmission tube 1 incorporated into a running board as is shown in FIG. 1 involves providing and attaching tube 1 to a surface that extends from the vehicle and is substantially adjacent to and below the access doors to the vehicle. Such a surface can be a running board, step, side bar, tube bar, “nerf bar”, or other surface typically having a substantially horizontal portion on a vehicle or merely the under carriage of the vehicle. The tube 1 is either incorporated into the running board so as to be flush therewith, or affixed thereto and extending therefrom, and in any case, in such a manner to provide illumination to the entire usable surface thereof. It is preferred that the illumination is substantially constant across the entire length of the tube and directionally oriented out from the tube, such as by the reflective layer thereof, to optimize lighting of the usable surface and minimize stray lighting away from the usable (to be illuminated) surface. Such stray lighting is undesirable as power limitations in the vehicle place restrictions on the amount of electrical power and thus light power available for an illuminated running board or the like. So minimization of stray lighting is important for maximizing bright illumination. By using LEDs and optical tubes, this system not only minimizes power usage, but also maximizes efficiency of light output and space of coverage.

Preferably, tube 1 can be positioned along the innermost edge of the top usable surface of the running board where the running board attaches to the vehicle and forms typically an acute angled area for receiving one's foot as that person steps onto the board to step up into the vehicle, or vice versa to exit. In this case, the light is directed outward only onto the top usable surface of the running board, such that the running board and at least the lower portion of the door are brightly illuminated. Depending upon the contour of the vehicle, the tube can or can not illuminate the entire side of the vehicle. In one embodiment, the tube 1 is oriented such that substantially all of the light illuminated from the tube is directed onto the running board so that no light illuminates outward above the level of the running board. In this manner, the light is not obtrusive to the eyes of the people approaching or otherwise in the vicinity of the vehicle.

Alternatively, the tube 1 can also be positioned along the outermost edge of the top usable surface of the running board where the light can be focused inward from the outermost edge to illuminate the surface of the step only. In this embodiment it is possible to configure and position the tube 1 such that no illumination is allowed away from the vehicle and into the eyes of the people approaching the vehicle or otherwise in the vicinity of the vehicle.

The tube 1 can also be positioned along the outermost edge of the top usable surface of the running board where the light can be focused inward from the outermost edge and also slightly upward to illuminate the surface of the step as well as the side of the vehicle. In this embodiment it is possible to configure and position the tube 1 such that no illumination is allowed away from the vehicle and into the eyes of the people approaching or in the vicinity of the vehicle.

Alternatively, it is possible to configure and position the tube 1 such that illumination is allowed away from the vehicle in a downward and outward direction to illuminate the ground. This can be accomplished with the tube 1 positioned on the outermost edge or underneath the running board.

The tube 1 can also be used as a puddle or ground illumination light. The tube can be attached to the bottom edge of the door or the side or inner face of the door such that opening of the door illuminates that area thereunder. The tube 1 can alternatively be attached to the bottom face of the mirror to accomplish similar illumination.

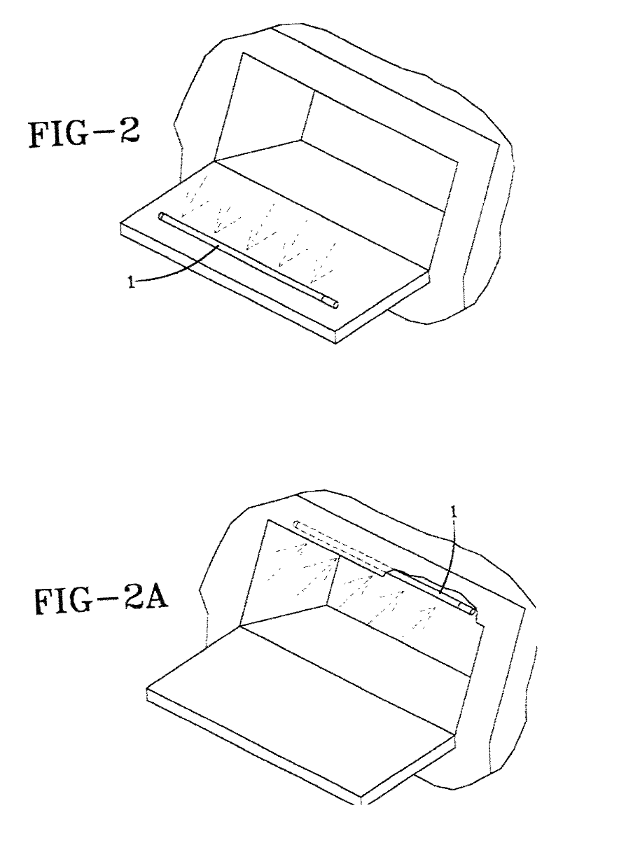

FIG. 2 shows a vehicle interior compartment such as a glove box, beverage area, ash tray or other vehicle interior compartment location with an optical transmission tube therein. The tube 1 can be positioned along an edge such as the front lower edge of an open compartment, or an outermost edge adjacent to a latch or other handle such as in a beverage pullout or glove box or on the face of the door thereof, or surrounding a desirable feature such as the cup holder. In any case of these embodiments, the light illuminates from the tube over its entire length and directionally oriented to brightly illuminate the desired area while not illuminating undesired areas such as the driver's area of a vehicle.

Such a tube 1 can also be positioned on the back surface of a seat so as to provide light to a seat positioned behind it such as a back seat in a car or any of the rows of seats in an airplane. The tube 1 provides for focused light such as on a tray as in an airplane or a specific area such as an individual's lap seated in the seat behind the seat containing the light tube therein. It is further noted that the tube can be rotatable as mounted or in a rotatable fixture to allow for directional adjustment. Within the interior of a vehicle, the tube 1 can also be positioned on door panels to illuminate features such as the handle, or to illuminate along the door at least when it is open to provide bright and noticeable illumination to other vehicle drivers in the vicinity. On the interior of an airplane, such a light can be used to illuminate space throughout the aircraft including the aircraft cove or ceiling, the restrooms, the exits, the floor, the galley, the cockpit, as well as externally of the airplane to the extent that the transmission tube can withstand the changes and temperature, pressure, and other forces common to flight.

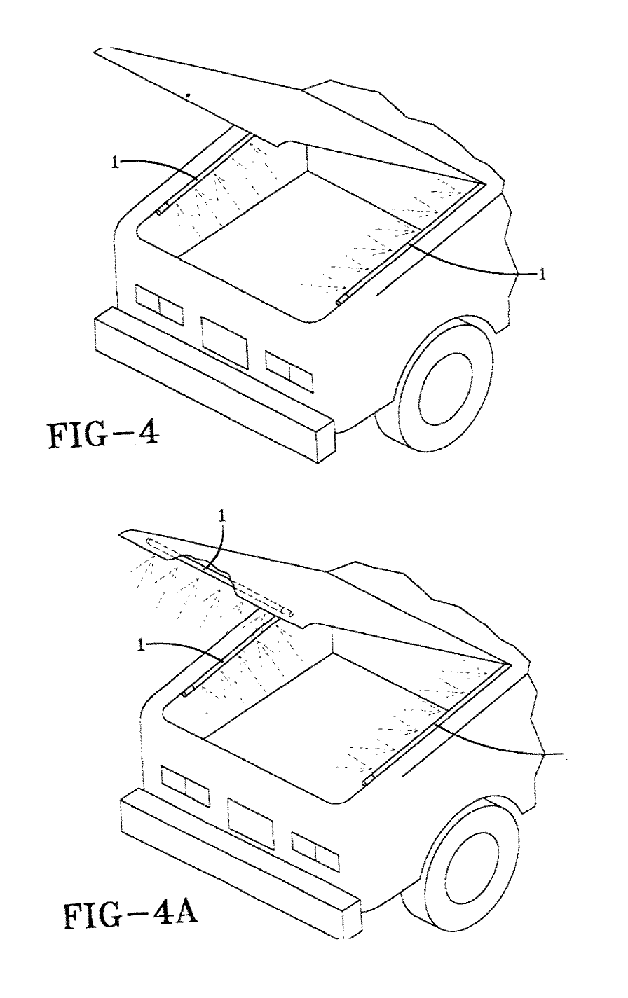

It is also contemplated that the tube 1 can be placed in other configurations or positions within a vehicle interior. Some examples include in the ceiling, on an arm rest, under the hood (as seen in FIG. 6), along the edge of the hatch or trunk to avoid running into it, adjacent a door handle to help in finding, or at a key hole.

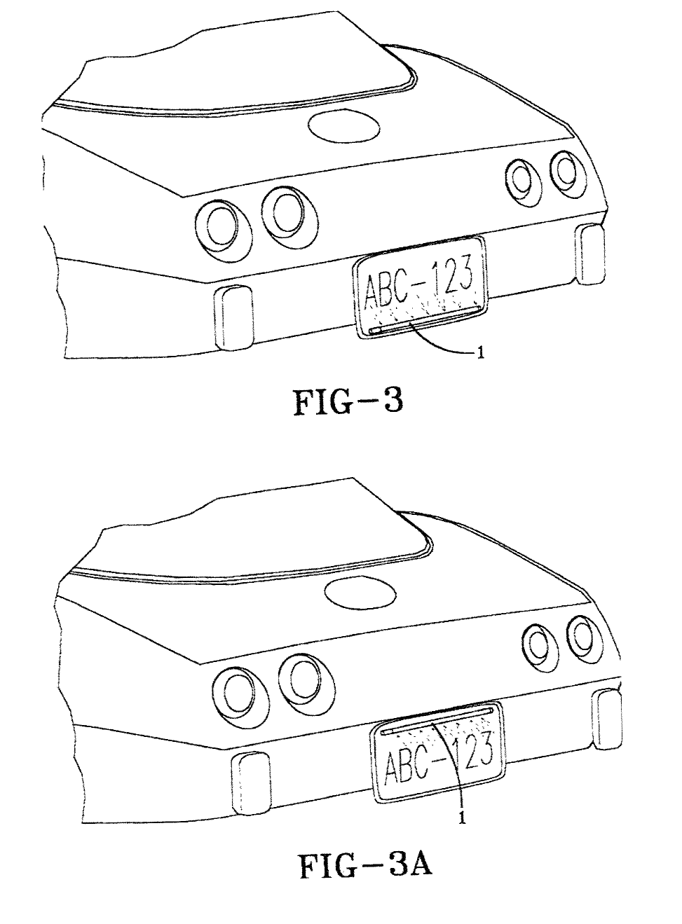

FIG. 3 shows a license plate attachment area on a vehicle with an optical transmission tube positioned therearound for illuminating the license plate. Tube 1 is integrated into or attached to the vehicle in such a manner to illuminate the license plate. In one scenario, the license plate area is a sunken area, defined by a plurality of side (such as a top, two sides, and a bottom) walls, for receiving the plate and the tube 1 is positioned along at least one of the side walls and directs light toward the license plate. Based on the ability to directionally emit light from the tube 1, the illumination can be limited to the license plate thereby providing bright illumination thereof and no stray light to annoy vehicle drivers following the vehicle having an illuminated license plate. This also enhances the ornamental appearance of the vehicle.

FIG. 4 shows a trunk with an optical transmission tube therein. The tube 1 can be positioned along the inside surface of the trunk at the outermost edge as a warning light, at any location on the inside surface of the trunk to illuminate the truck, inside of the trunk compartment such as over, around, near or approximate the spare tire to illuminate the often dark backmost portion of the trunk, or along the side walls of the trunk compartment to illuminate the trunk. The directional control of the lighting in the tube 1 allows for specific control of the direction of the light illuminating from the tube such that it is maximized on the cargo compartment of the trunk defined as the walls, floor and trunk lid.

In another embodiment, a tube 1 is provided on the inside surface of the hood, or on the inner walls of the engine compartment.

FIG. 5 showsa truck bed with an optical transmission tube therein. The tube 1 is provided along the interior of the truck bed at any location although preferably just under the top lip such that the tube is oriented to provide illumination to the entire interior of the truck bed while limiting stray light. In another embodiment, the optical transmission tube is used within a bedliner.

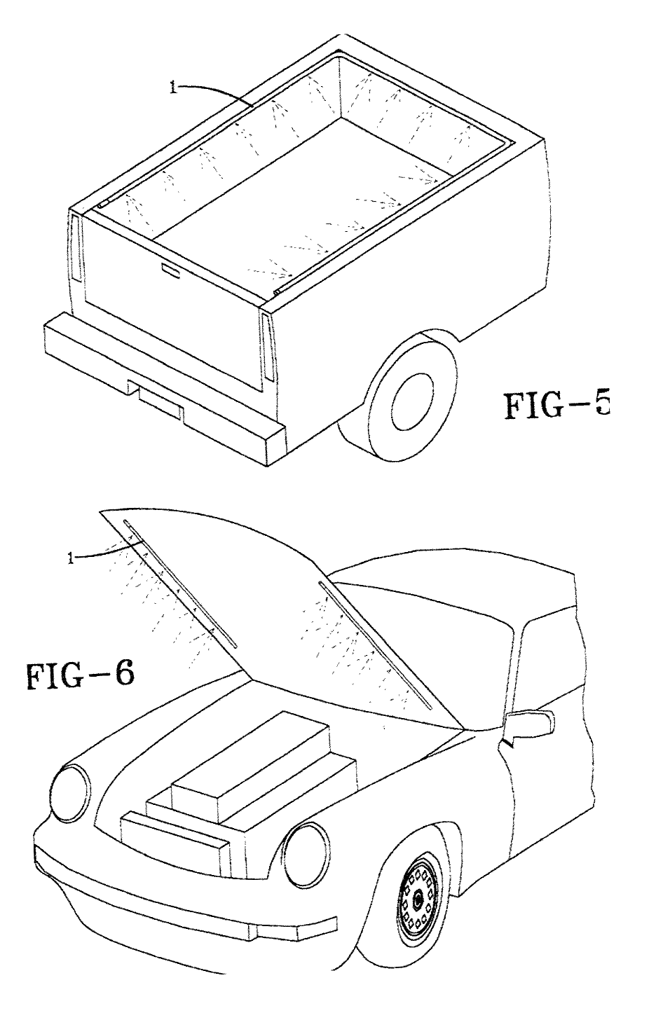

The tube 1 is attachable to the exterior of a vehicle such as is shown in FIG. 7. The tube can extend along a section of the vehicle to illuminate such section such as along a door guard strip or side molding. Alternatively, the tube can be attached approximate any portion of the vehicle that extends outward beyond the general envelope of the vehicle, such as a tailgate or hatch when open, a mirror as it extends from the vehicle, or the like.

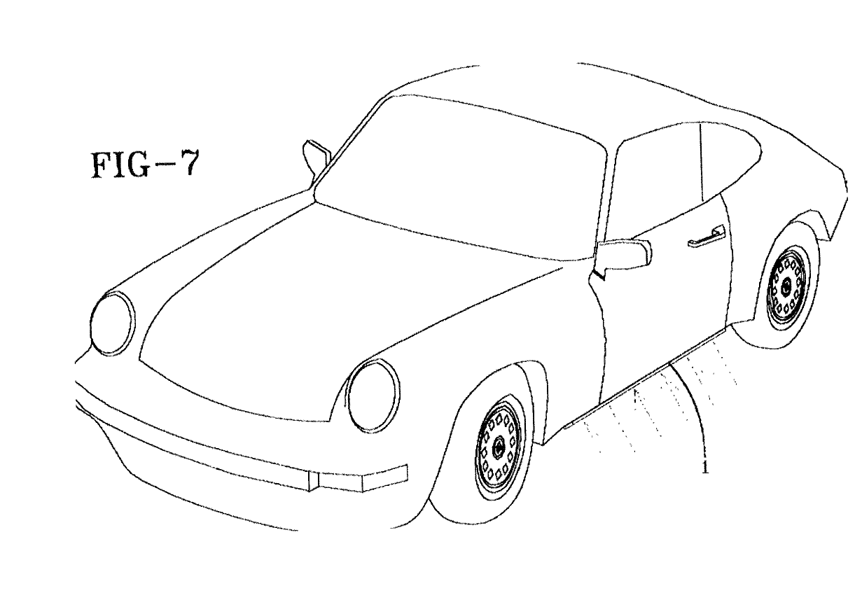

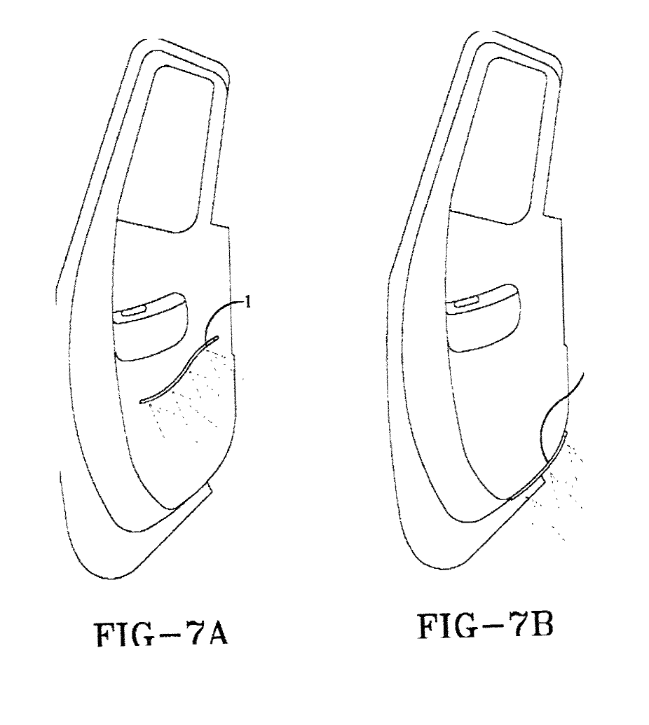

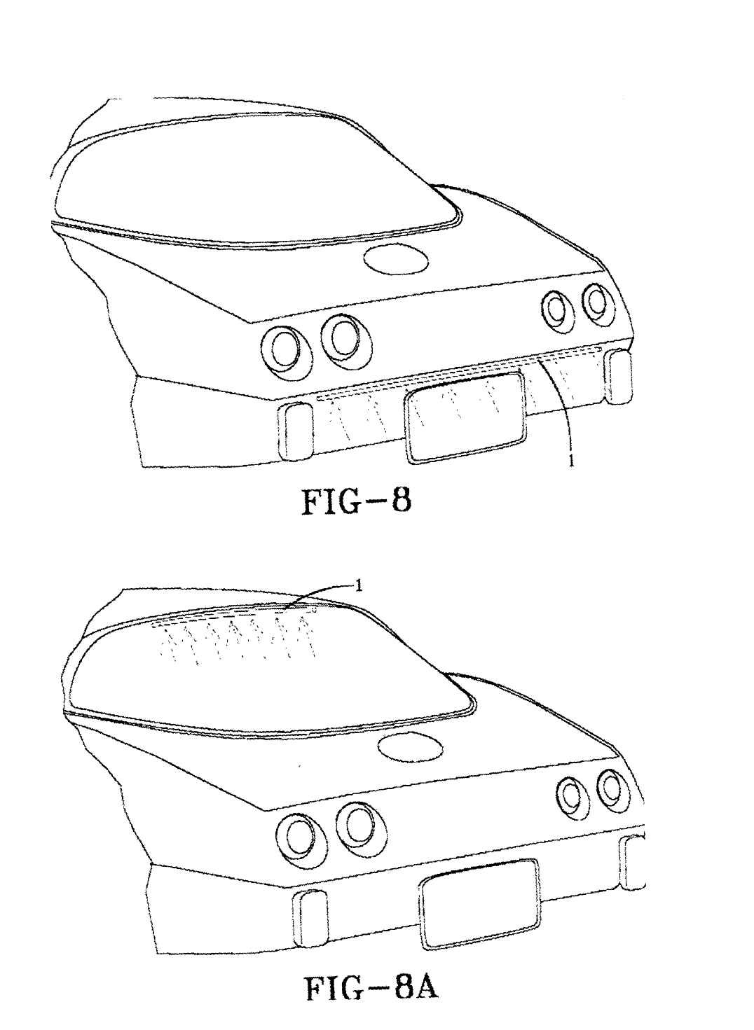

The tube 1 can be integral or attached to a vehicle bumper to provide safety illumination thereof. FIG. 8 is a perspective view of one configuration of a vehicle bumper with an optical transmission tube therein.

The tube 1 can also be integral or attached to a vehicle luggage rack on top of the vehicle. FIG. 9 is a perspective view of one configuration of a vehicle luggage rack with an optical transmission tube therein.

FIG. 10 shows a picture frame with an optical transmission tube thereon. Such a tube 1 can be provided for illuminating the picture contained therein whereby the directional emitting of light from the tube 1 is directed at the picture to provide maximum brightness to the picture and minimized stray light on the surrounding area and in the eyes of persons viewing the picture. The tube 1 can alternatively be used to accent the entire or a portion of the frame.

FIG. 11 shows a flash light embodiment including an optical transmission tube. The tube provides light of a focused nature as is desirable from a flash light in a conical fashion.

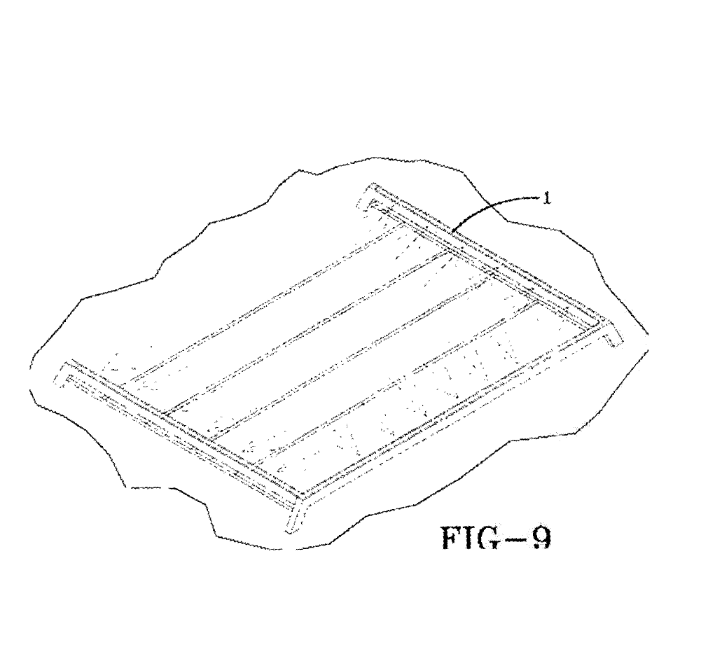

FIG. 12 shows the invention embodied as a building with an optical transmission tube thereon. The tube 1 can be used to illuminate a specific portion of the building such as a low clearance underpass, the area around a loading bay door, emergency exit doors, a helicopter landing pad such as at a hospital, or the overall outline of the entire building for aesthetic purposes. The directional light emitting capabilities of the tube provide for light illumination where desired while minimizing or eliminating such illumination where it is not desired.

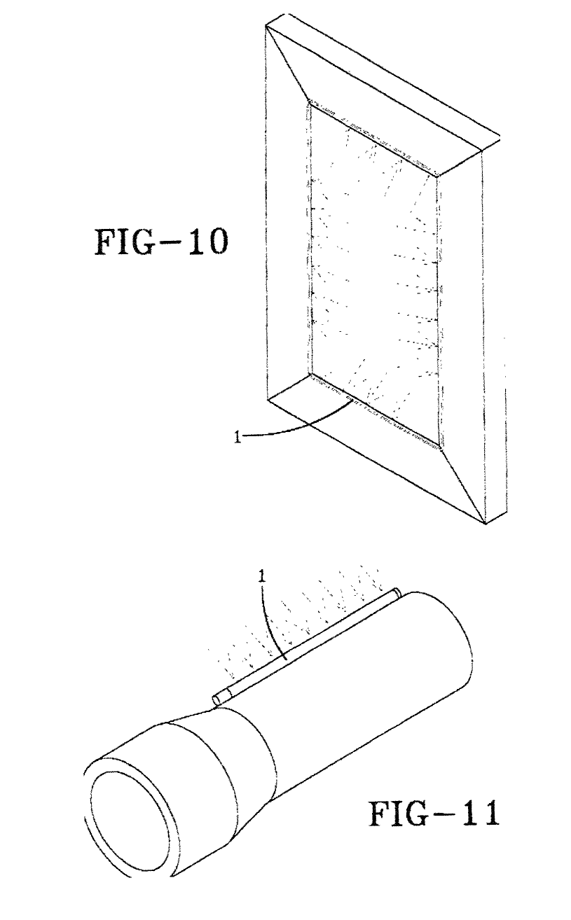

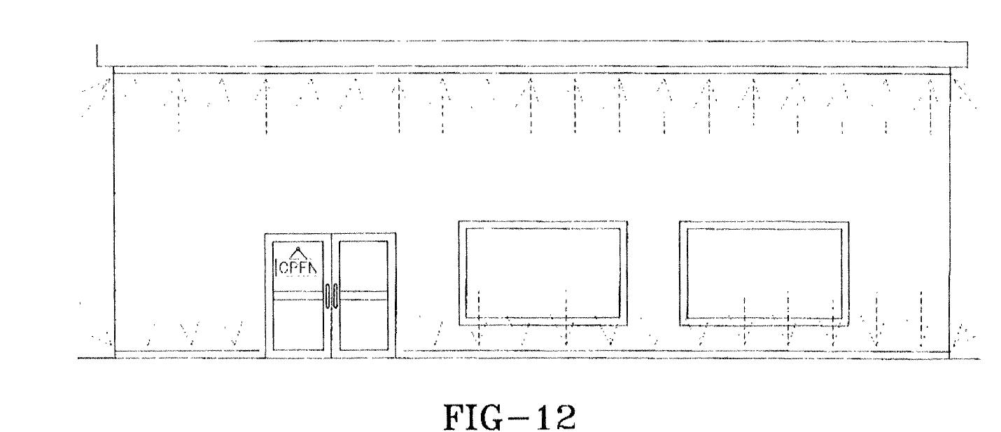

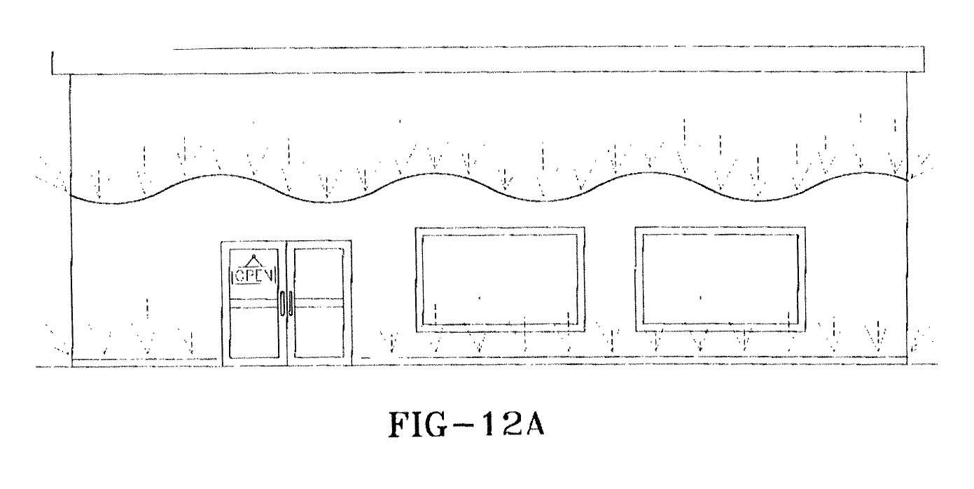

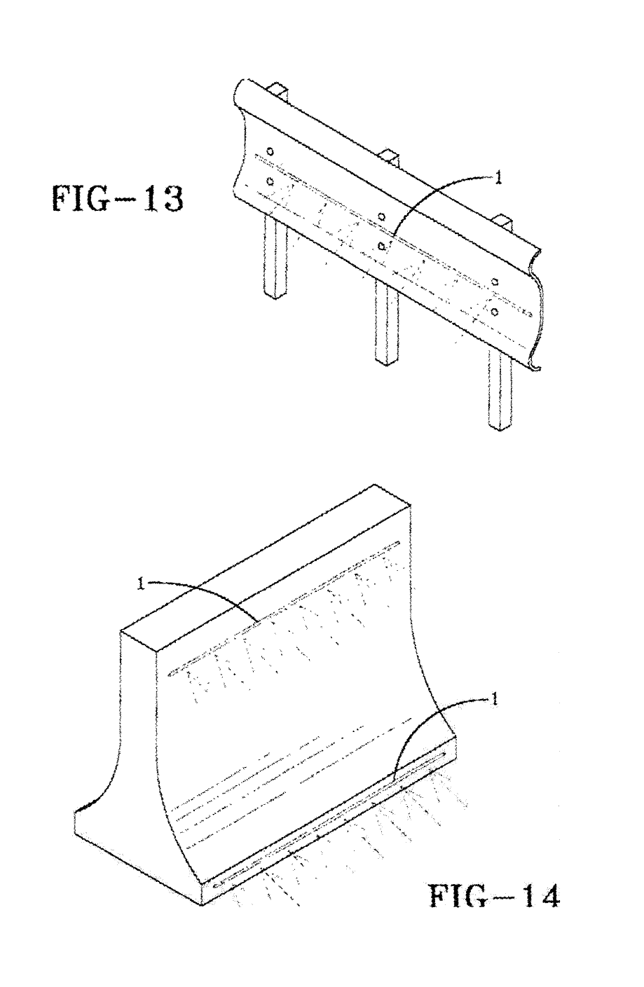

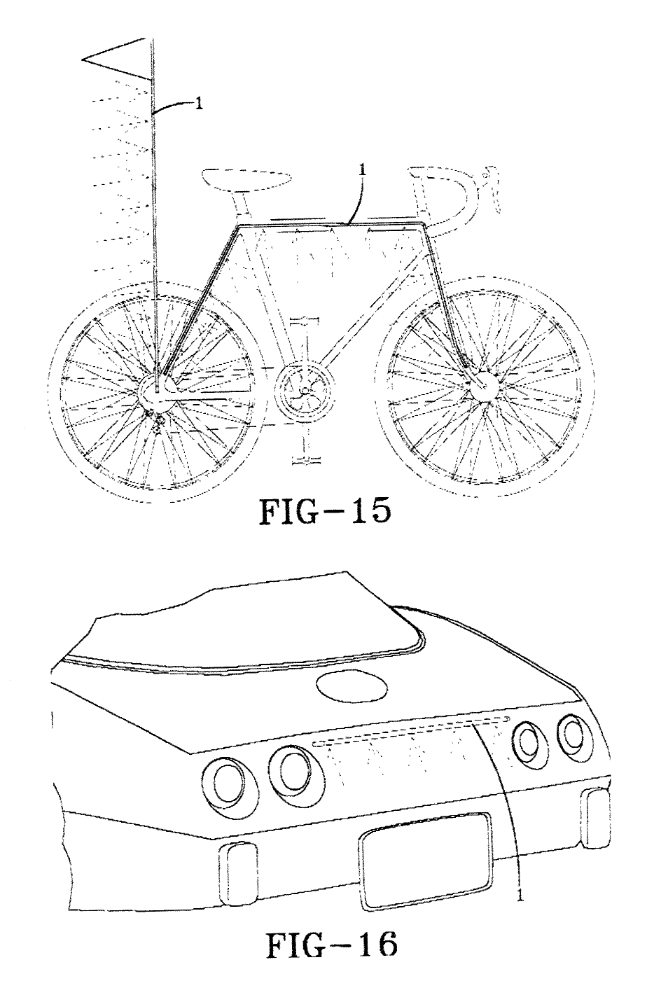

FIG. 13 shows the invention embodied as a guard rail with an optical transmission tube therein. Guard rails, “jersey” walls, or other road curve delineation markers provide guidance to vehicle drivers about impending curves, jogs, or other changes in road direction as well as the end of a road or edges of roads (such as highlighting a ditch or curb). At night, these guard rails or other road curve delineation markers are often difficult to see even with reflectors thereon. The reflectors are often small and insufficient to be seen by a vehicle operator concentrating on the road direction. Tube 1 is attached to the guard rail and preferably extends along a substantial portion thereof so as to illuminate the guard rail such that it is readily viewed by vehicle drivers. Tube 1 can be affixed within the recesses the guard rail, or alternatively affixed to the top or bottom edge or lip of the guard rail, or otherwise positioned to be readily viewable by vehicles. The tube 1 provides evenly distributed light over approximately its entire length, and the reflecting layer focuses the radially emitted light outward in a desirable angular range.

In another embodiment, a construction barrier has an optical transmission tube therein as is shown in FIG. 14. The construction barrier can be a cone, barrel, barricade or other barrier. The tube 1 emits bright and focused light therefrom thereby providing a bright and readily noticeable barrier rather than one reliant upon reflective tape, reflectors or small and dim beacon type lighting.

In yet another embodiment, a bicycle includes an optical transmission tube thereon. The tube can extend axially along any of the structural supports or members of the bicycle, or alternatively along the back edge of the seat or across the handle bars.

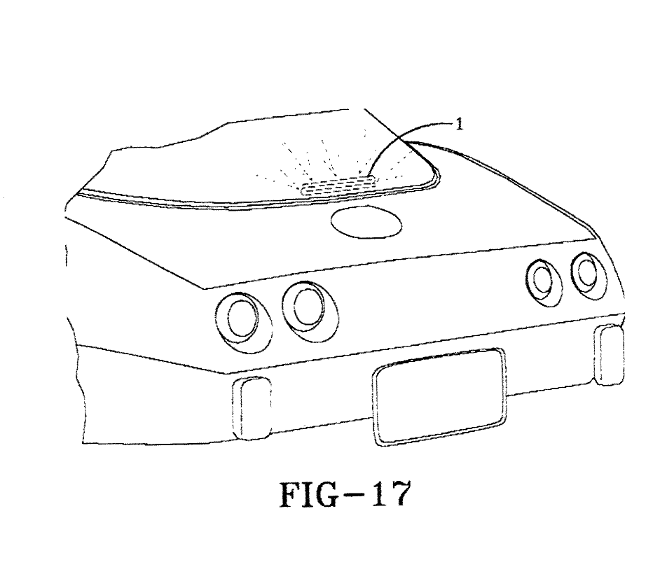

In still a further embodiment, the present invention includes an optical transmission tube attached to the exterior back side of a vehicle for use as either a tail light (FIG. 16) or a third brake light often referred to as a CHMSL [defined already above] or center high mounted stop light (FIG. 17).

In yet another embodiment, an optical transmission tube is configured as a portable vehicle or home reading light as is shown in FIG. 18.

In another embodiment, the optical transmission tube is adhered to a sign within the letters (FIG. 19) or along the edge of the letters so as to trace the letters. This results in bright illumination of the letters. In addition, the reflecting layer in the tube provides for controlled direction of the illumination from the sign. The tube can also be adhered to decorative letters, numbers, shapes or designs such as is shown in FIG. 40. The invention can also be used to backlight the sign or place a wash of light across the surface (such as occurs on freeway signs).

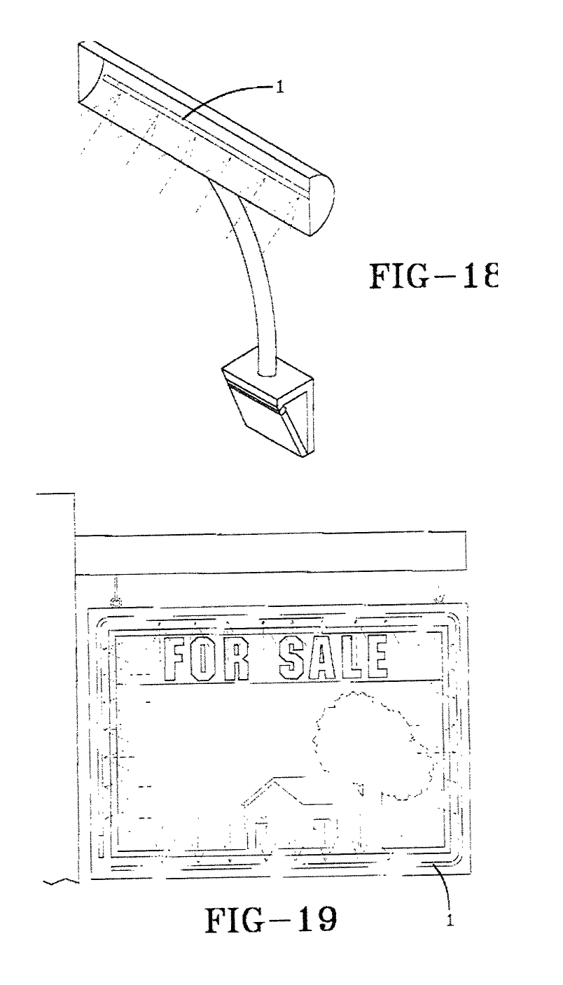

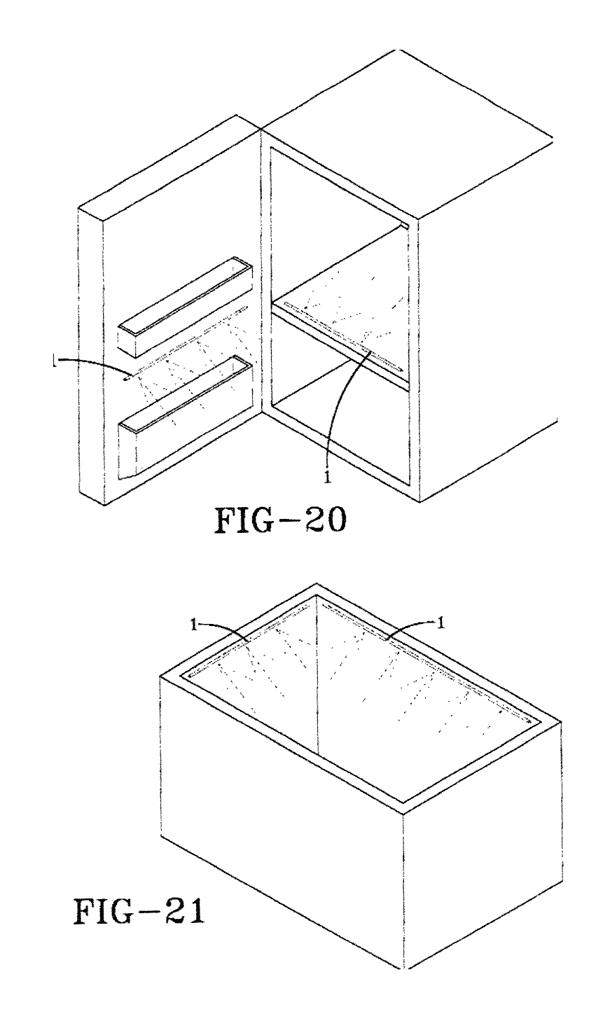

In yet another embodiment, the optical transmission tube 1 is attached to an appliance interior compartment such as a refrigerator as is shown in FIG. 20. The tube can be positioned along any wall or other surface, shelf, or door to provide illumination to the compartment.

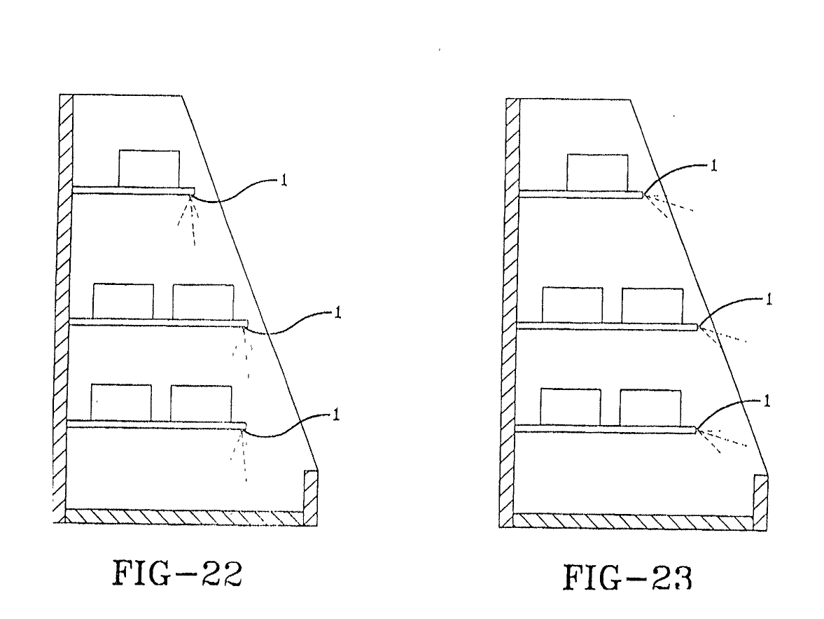

In still yet another embodiment, the optical transmission tube is affixed to a part bin (FIG. 21), shelf such as a retail display shelf (FIGS. 22 and 23), or other display to provide for lighting of the inside of the compartment or the areas above or below the shelf. In one example, the tube is affixed underneath each shelf on a shelving unit such as in a retail establishment thereby providing for lighting of some or all of the shelves and the product displayed thereon. The tube can be attached along the outer frontmost edge of a shelf as shown in FIG. 23, or underneath the shelf as shown in FIG. 22. In the case of the outer edge, the tube can be configured so as to direct its light in the desired direction, likely downward and slightly inward to illuminate the product on the shelf below, or directed outward to draw customer attention to that particular shelf and the product thereon.

FIG. 24 shows the use of an optical transmission tube attached to a clipboard or like device for holding a pad of paper. The tube is attached to the clip board along the top or side edge thereof, and possibly adjacent to or incorporated in with the clip mechanism. The light emitted from the tube illuminates the clip board evenly, and when properly positioned, the reflecting layer focuses the light intensity onto the board and away from the user.

It is also contemplated that the tube can be affixed along one of the edges of a bulletin board so as to illuminate it properly also, or mounted along the edge to draw attention to it.

An optical transmission tube may be used in the valley portion of a step as shown in FIG. 25. The tube is configured so as to direct light in a preferred direction such as out over the horizontal face of the step while not diagonally or vertically upward into the eyes of users of the steps. The tube can also be incorporated into the outer peak of the step and covered with a protective casing if necessary whereby the light is then directed downward onto the step below.

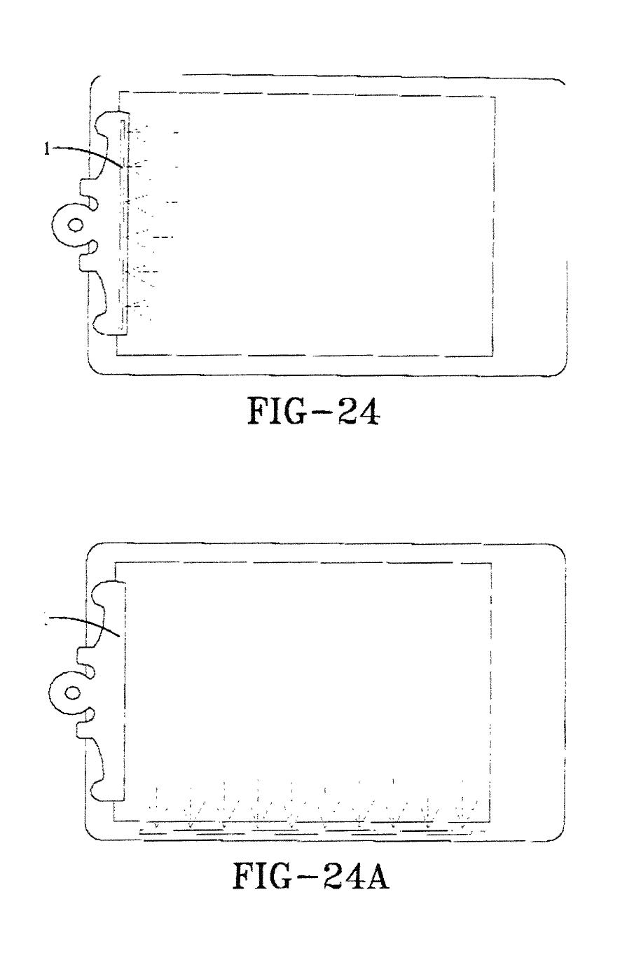

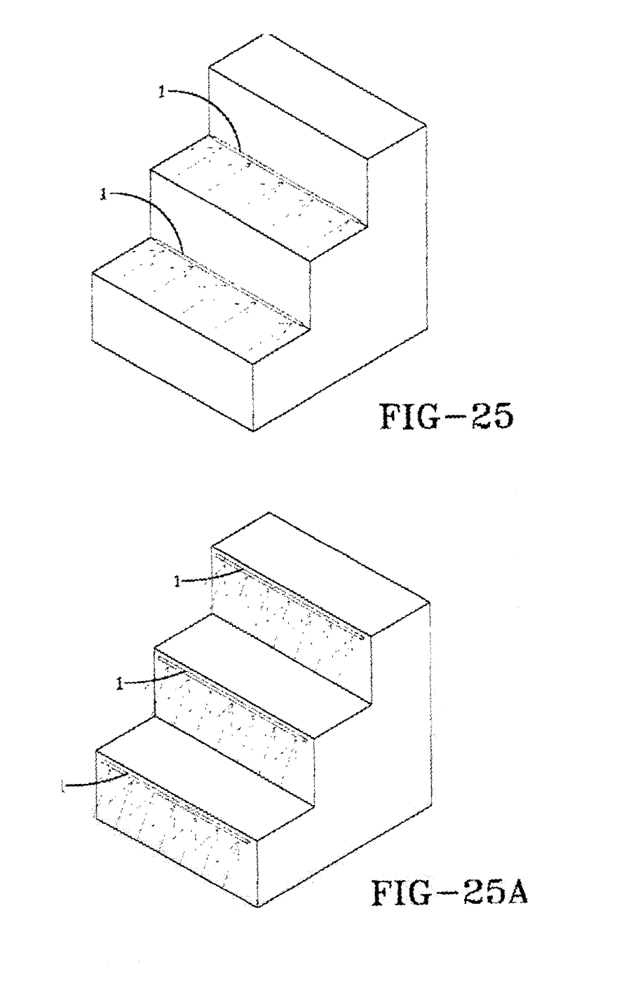

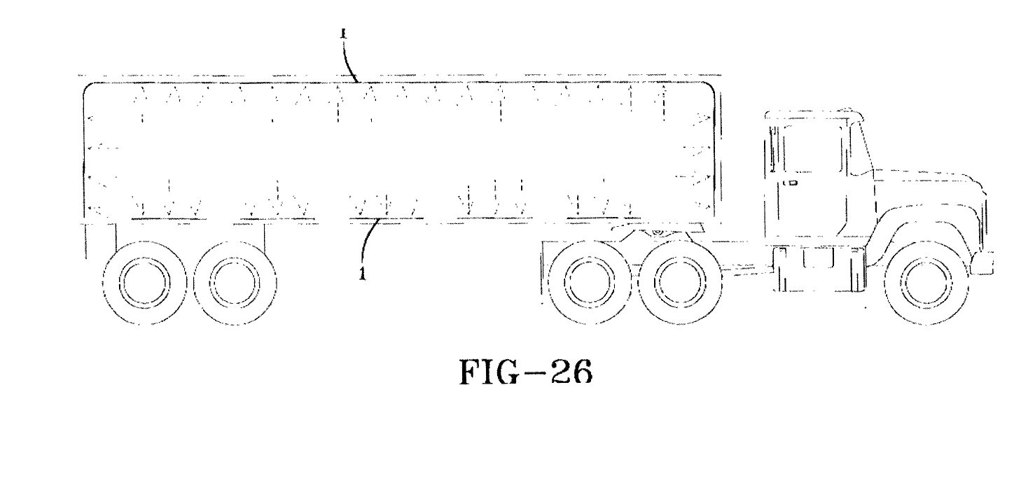

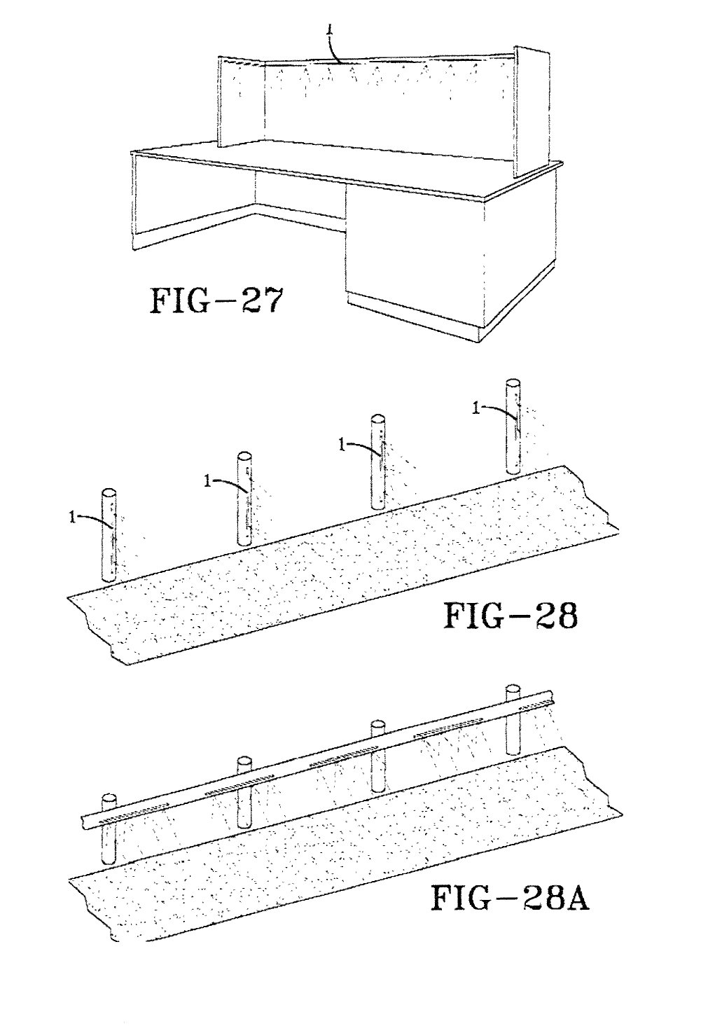

FIG. 26 shows the present invention as a tractor trailer with an optical transmission tube thereon as running lights or to outline the truck.

Another embodiment includes a desk with an optical transmission tube thereon. In the case of a roll top desk or other modular desk with a structure above the writing/reading surface, the tube is installed on this structure and provides for light that is evenly distributed axially while radially directed due to the reflecting layer in the tube thereby providing for bright light focused on the writing/reading surface only, and not illuminating outward such as toward the direction the user would be positioned.

The invention can also include a walkway with walkway path edge markers with an optical transmission tube therein as is shown in FIG. 28. The tube is configurable such that the walkway is illuminated but light is not directed upward into the eyes of walkers using the walkway. The invention can further be used to illuminate a room or storage chamber with the optical transmission tube therein along the floor, walls, ceiling, doors, windows or other structure thereof as is shown by way of example in FIG. 29.

FIG. 30 shows a runway with runway markers including an optical transmission tubes thereon.

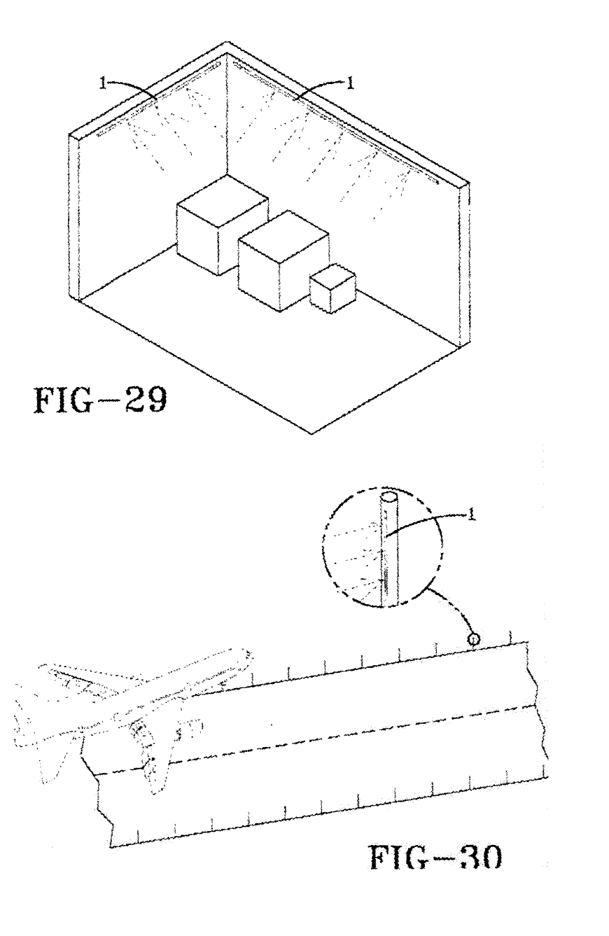

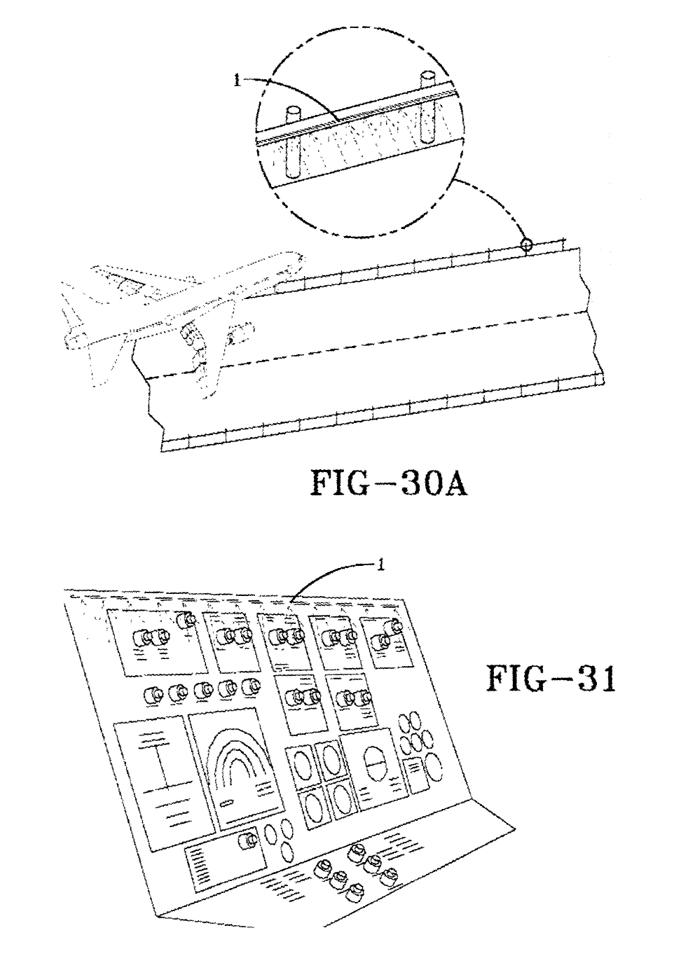

FIG. 31 shows an instrument panel with an optical transmission tube thereon. The tube is used to illuminate the entire (or a portion) instrument panel of any machinery such as a tractor, automobile, truck, airplane, boat or motorcycle. It could be used to backlight the panel, or wash light across it.

Another application is use in the railroad industry as is shown in FIG. 32. The invention is a railroad crossing gate with an optical transmission tube thereon. The tube can be positioned along the top edge of the gate or alternatively along any of the black and white lines painted on the gate.

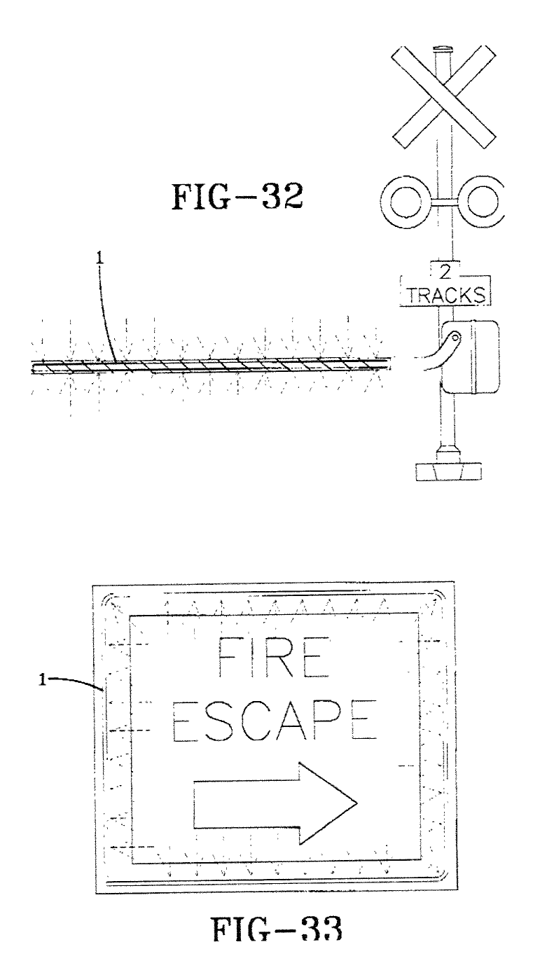

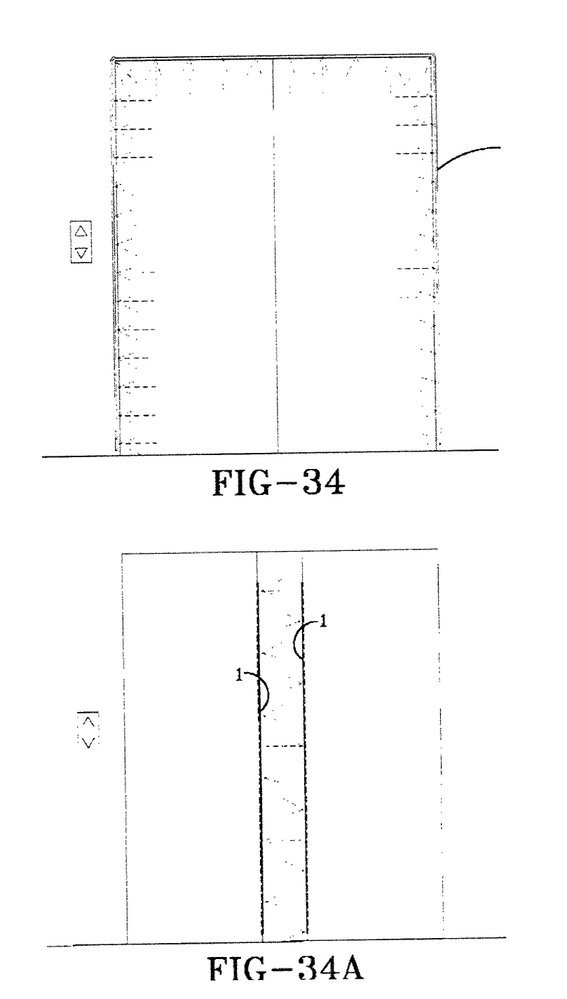

The present invention is also configurable as shown in FIG. 34 for use on an elevator door. Specifically, the optical transmission tube 1 is attached to the elevator doors to illuminate the doors as the doors open and close. It is also contemplated that the lower edge of the elevator and corresponding edge of the floor the elevator is aligned with can include tubes to illuminate the edges, particularly when not perfectly aligned.

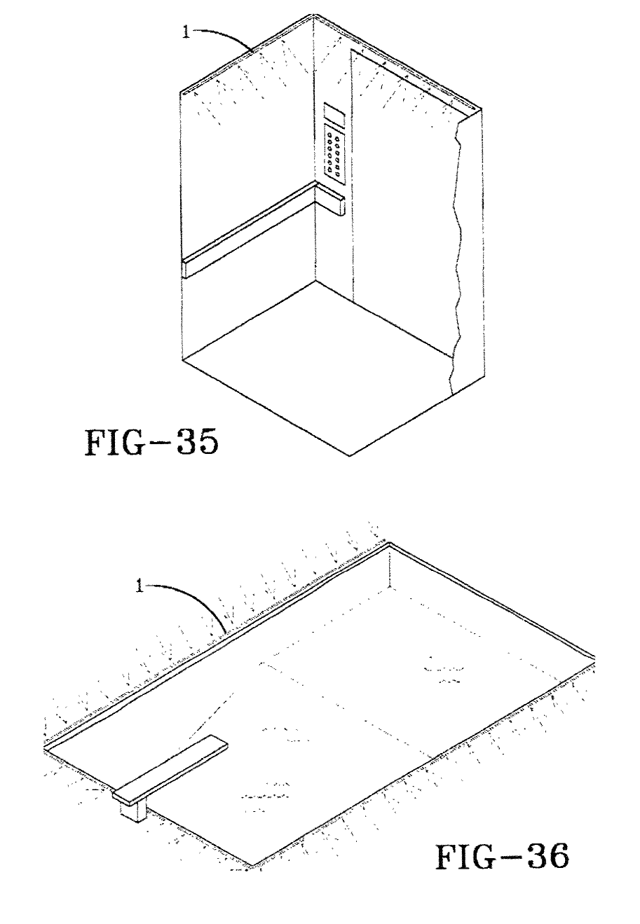

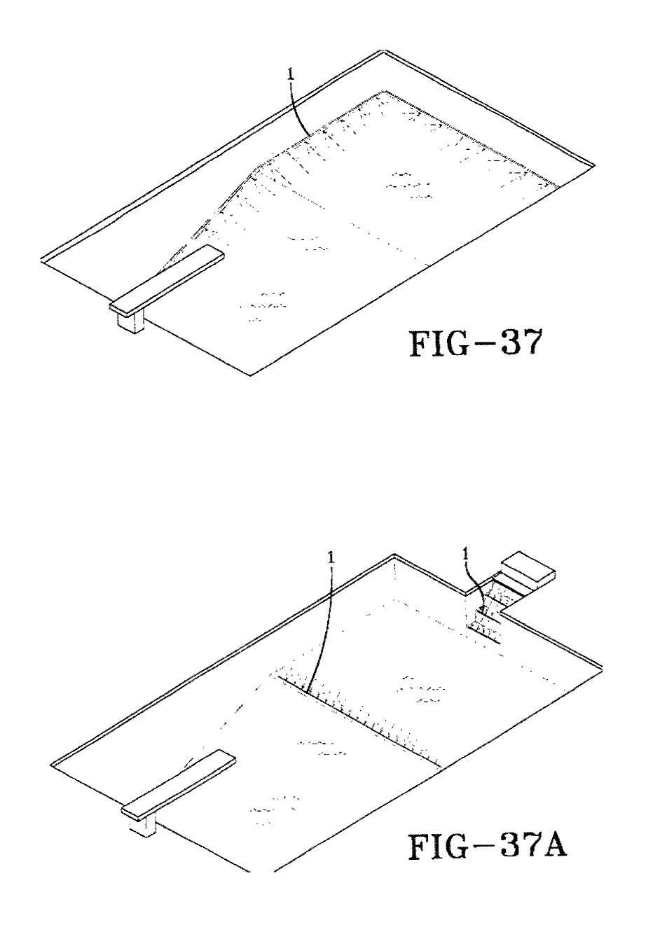

Another embodiment involves use of the optical transmission tube in or around a swimming pool. FIG. 36 show an optical transmission tube along the edge of a swimming pool. It is also usable as shown in FIG. 37 on steps, diving boards, and even under the water along the bottom edges to illuminate the water and define the depth and edges therein.

Another embodiment is shown in FIG. 38 on a dog collar. The tube attached to the dog collar illuminates so persons can see and find the dog in the absence of other light sources.

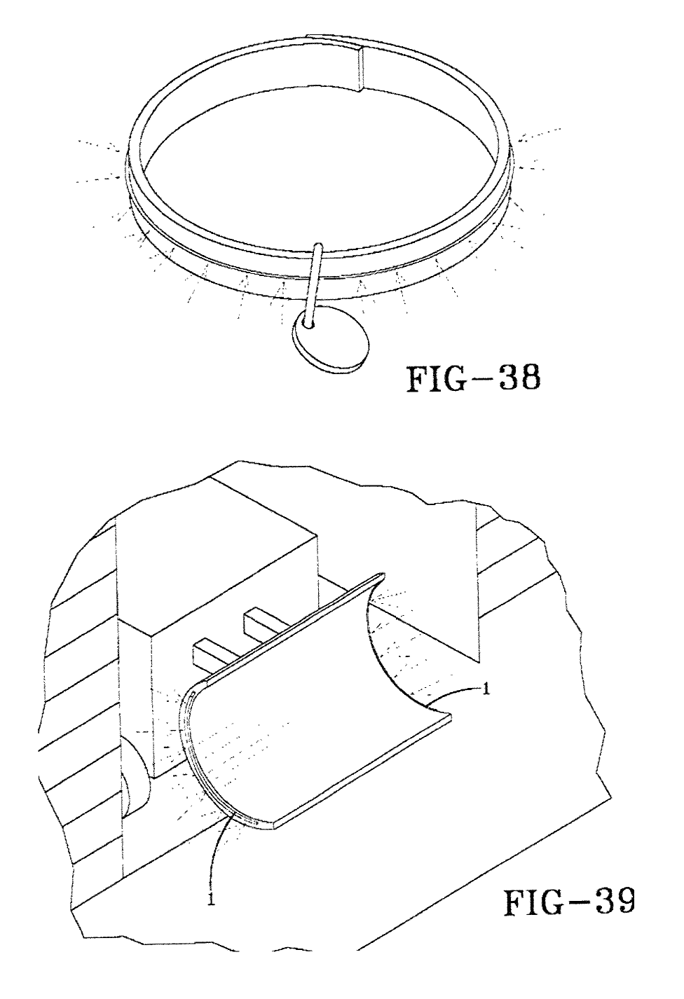

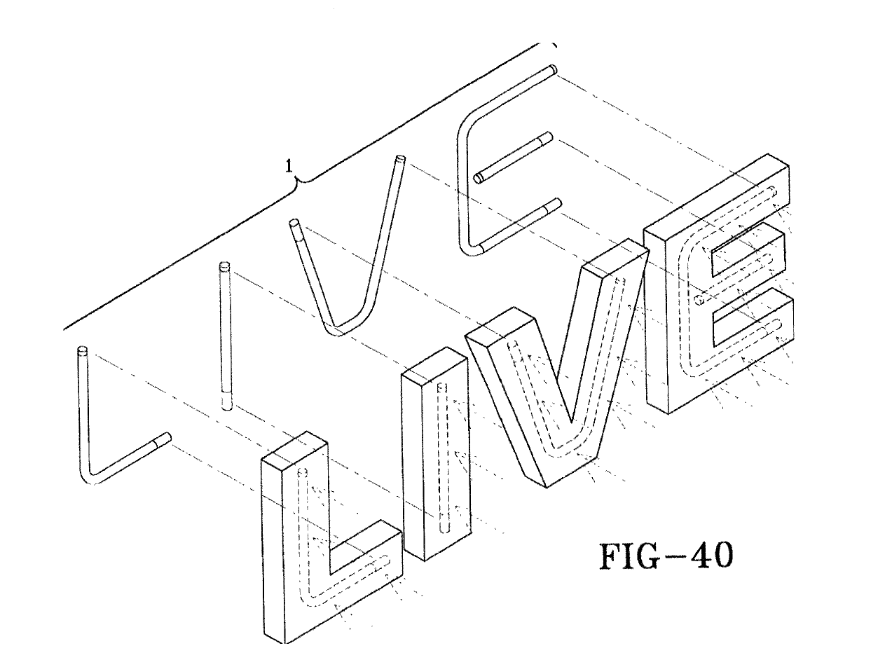

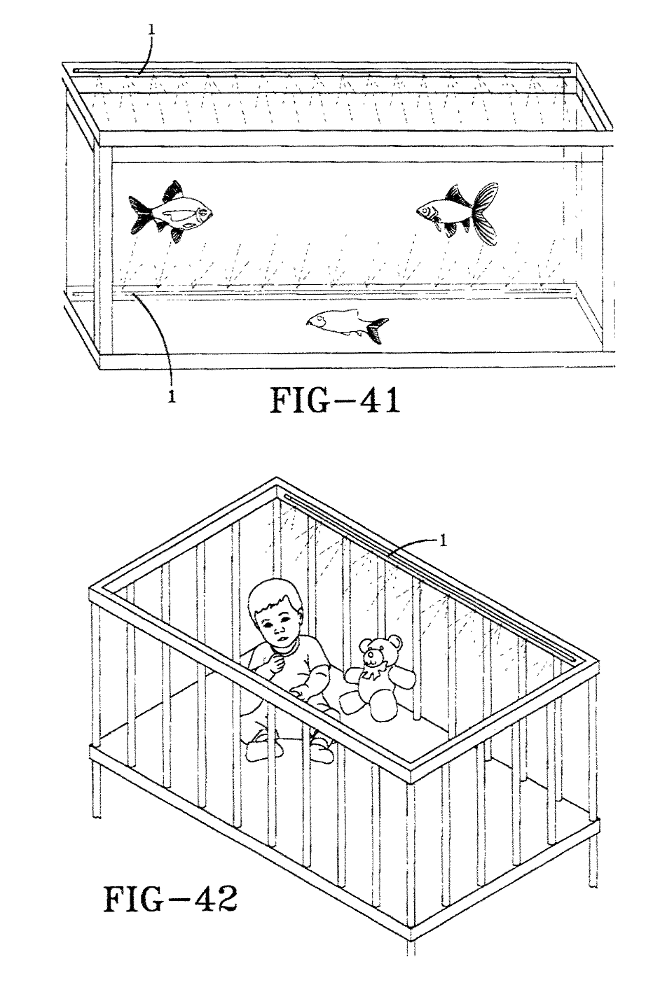

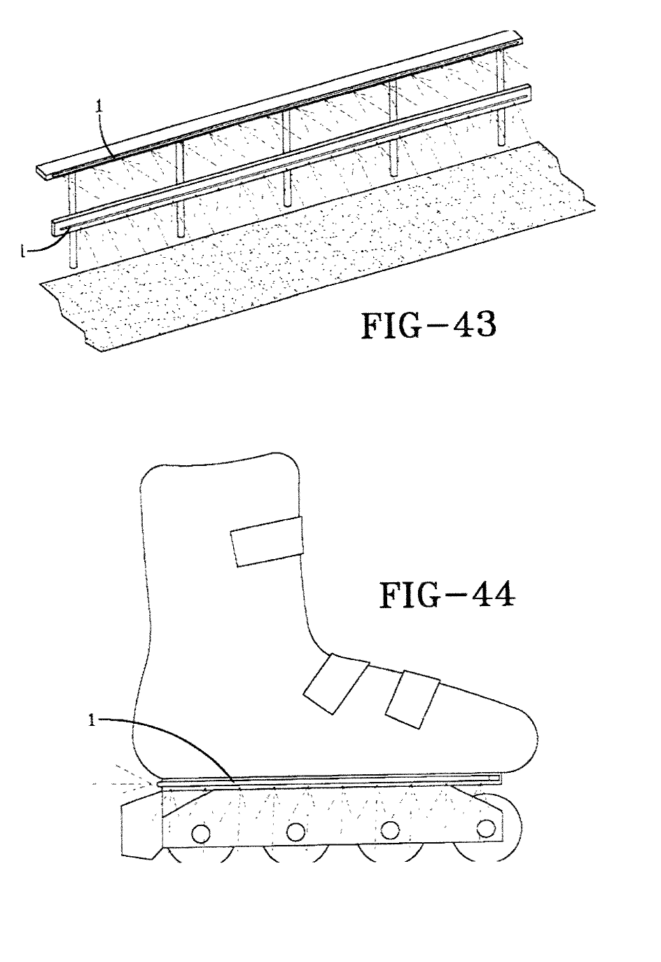

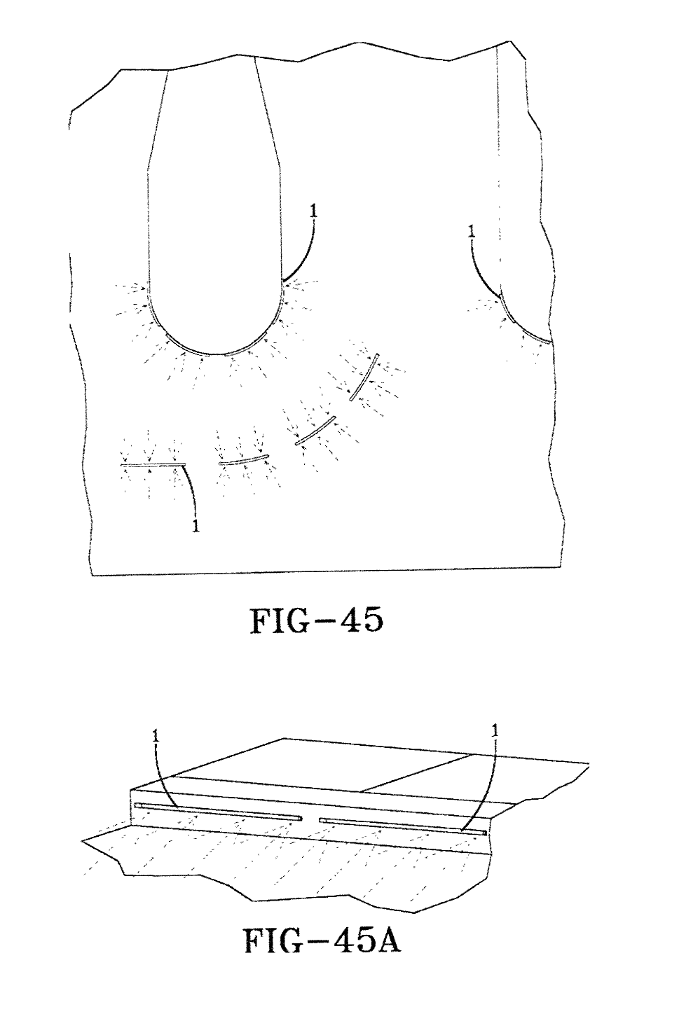

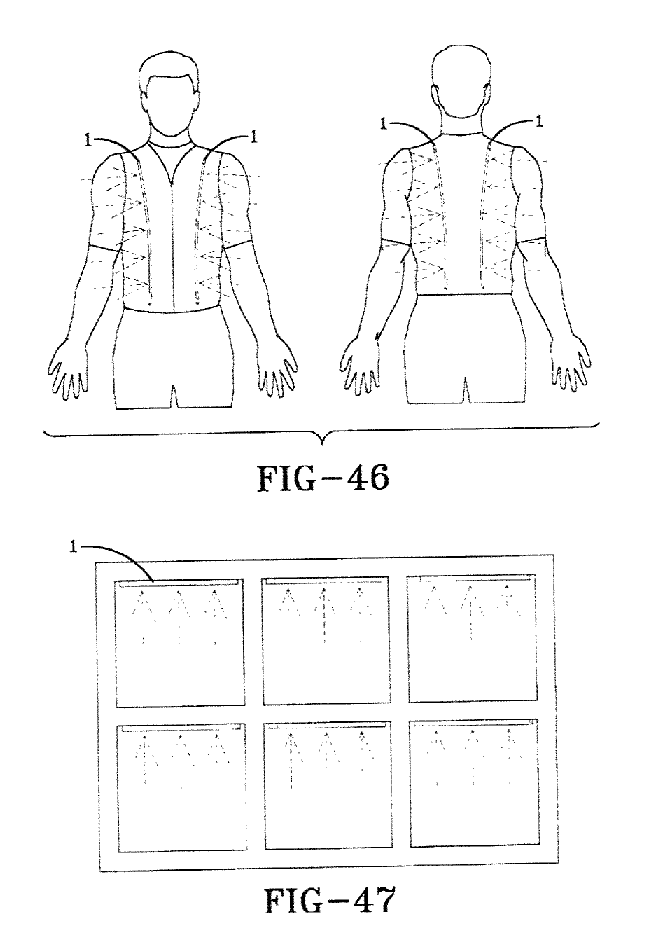

The invention is also usable as a hazard marker as is shown in FIG. 39 where the tube is attached to a hazard such as a pipe or structural feature extending across a walkway or other access area, or an attachment such as a snow plow extending from a vehicle or structure.

Other uses include on toys such as an illuminated basketball back board, target, and a fishing net. The optical transmission tube can also be configured to be portable and usable temporarily such as in the application of a military landing zone that is temporarily built and thus needs temporarily illuminated. Another military use is illumination on the exterior of military equipment for night identification to identify the equipment (such a tank, plane, etc.) as your side or enemy (ultraviolet light).

The present invention often requires a specific configuration or positioning to assure that the reflecting layer is properly positioned to illuminate in the desired direction. This is accomplished by using a key in the end of the fiber optic tube 1 so that the tube 1 only fits with the light source 2 or a mounting bracket in a single manner. Specifically, a small groove is ground into at least one end of the tube and this groove corresponds in size, shape and configuration to a key that extends inward from the outer wall of the socket in the light source or mounting bracket that receives the tube.

It is alternatively contemplated that a D shaped tube with the flat part having the reflector therein can be used. It is even further contemplated that asymetrical designs can be used.

Accordingly, the invention as described above and understood by one of skill in the art is simplified, provides an effective, safe, inexpensive, and efficient device, system and process.

In the foregoing description, certain terms have been used for brevity, clearness and understanding; but no unnecessary limitations are to be implied therefrom beyond the requirement of the prior art, because such terms are used for descriptive purposes and are intended to be broadly construed.

Moreover, the invention's description and illustration is by way of example, and the invention's scope is not limited to the exact details shown or described.

The invention is not limited to the above embodiments. The claims follow.

We claim:

1. A shelving unit comprising a frame for supporting a shelf having a top surface on which items can be stored or displayed, an outermost edge, and a bottom surface, the shelf further including an optical transmission tube affixed thereon, said optical transmission tube including a light emitting diode and an elongated transparent body capable of allowing light to be transmitted substantially along its entirety from the light emitting diode positioned approximate at the end of the body.

2. The shelving unit of claim 1 wherein the optical transmission tube is affixed to the bottom surface of said shelf.

3. The shelving unit of claim 1, wherein the optical transmission tube is affixed to the outermost edge of said shelf.

4. A sign comprising a front semi-transparent or transparent surface and an optical transmission tube affixed behind the surface for illuminating graphics through the semitransparent or transparent surface, and said optical transmission tube including a light emitting diode and an elongated transparent body capable of allowing light to be transmitted substantially along its entirety from the light emitting diode positioned approximate at the end of the body.

5. The sign of claim 4 wherein the semi-transparent or transparent surface contains graphics thereon.

6. A flashlight comprising an elongated body housing a power supply compartment, and including an optical transmission tube affixed thereto for illuminating outward therefrom, and said optical transmission tube including a light emitting diode and an elongated transparent body capable of allowing light to be transmitted substantially along its entirety from the light emitting diode positioned approximate at the end of the body.

7. A storage bin having interior and exterior surfaces and including an optical transmission tube affixed thereto for illuminating outward therefrom, and said optical transmission tube including a light emitting diode and an elongated transparent body capable of allowing light to be transmitted substantially along its entirety from the light emitting diode positioned approximate at the end of the body.

8. The storage bin of claim 7 wherein the optical transmission tube is affixed to an interior surface, thereby illuminating the interior of the storage bin.

9. The storage bin of claim 7 wherein the optical transmission tube is affixed to an exterior surface, thereby illuminating at least part of the structure of the storage bin.

10. An article of clothing having an optical transmission tube affixed thereto for illuminating outward therefrom, and said optical transmission tube including a light emitting diode and an elongated transparent body capable of allowing light to be transmitted substantially along its entirety from the light emitting diode positioned approximate at the end of the body.

11. An inline skate having an optical transmission tube affixed thereto for illuminating outward therefrom, and said optical transmission tube including a light emitting diode and an elongated transparent body capable of allowing light to be transmitted substantially along its entirety from the light emitting diode positioned approximate at the end of the body.

12. A clipboard comprising a flat surface with a clip attached thereto, and having an optical transmission tube affixed thereto for illuminating the surface of the clipboard and said optical transmission tube including a light emitting diode and an elongated transparent body capable of allowing light to be transmitted substantially along its entirety from the light emitting diode positioned approximate at the end of the body.

13. The clipboard of claim 12 wherein the optical transmission tube is affixed to the clip.

14. The clipboard of claim 12 wherein the optical transmission tube is affixed to the surface of the clipboard.
